(19) United States
(12) Patent Application Publication
(10) Pub. No.: US 2023/0036299 A1
(43) Pub. Date: Feb. 2, 2023

(54) METHOD OF AUTOMATICALLY CREATING ACCOUNTS, ELECTRONIC DEVICE, AND COMPUTER STORAGE MEDIUM

(71) Applicant: Shenzhen Fulian Fugui Precision Industry Co., Ltd., Shenzhen (CN)

(72) Inventors: XIAO-YONG DUAN, Shenzhen (CN); YAN-QING MAO, Shenzhen (CN); LIANG ZHANG, Shenzhen (CN)

(21) Appl. No.: 17/587,112

(22) Filed: Jan. 28, 2022

(30) Foreign Application Priority Data
Jul. 27, 2021 (CN) 202110853967.4

(51) Int. Cl. H04L 9/40

(52) U.S. Cl. CPC H04L 63/083; H04L 63/102; H04L 63/20

(57) ABSTRACT

In a method of automatically creating accounts, a user identifier and a password are obtained in response to a request of a user for login to a system. Whether the user identifier exists in the first database is determined. When the user identifier does not exist in the first database, whether the user identifier and the password conform to an account rule is determined. When the user identifier and the password conform to the account rule, an account for the user is created according to the user identifier and the password. The method improves the ease and efficiency of creating, accounts.

### FIELD

The present disclosure relates to information security, and particularly to a method of automatically creating accounts, an electronic device, and a computer storage medium.

### BACKGROUND

When a user try to login to a website or system, it is usually necessary to authenticate the user for access to the website or system. A common authentication method is to validate a user identifier and a password entered by the user. A website or system may have an administrator responsible for creating accounts for users. If there is a large demand for new accounts, the administrator needs to create the new accounts one by one, which is inefficient and slow.

### BRIEF DESCRIPTION OF THE DRAWINGS

FIG. 1 shows a flow chart of one embodiment of a method of automatically creating accounts of the present disclosure.

FIG. 2 shows a flow chart of another embodiment of a method of automatically creating accounts.

FIG. 3 illustrates an electronic device for automatically creating accounts according to one embodiment of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

The embodiments of the present disclosure provide a method of automatically creating accounts, an electronic device, and a computer-readable storage medium. The method can be applied to the electronic device. The electronic device can be a terminal device or a server. The terminal device can be a mobile phone, a tablet computer, a notebook computer, a desktop computer, a personal digital assistant, a wearable device, or other electronic devices. The server can be a single server or a server cluster composed of multiple servers.

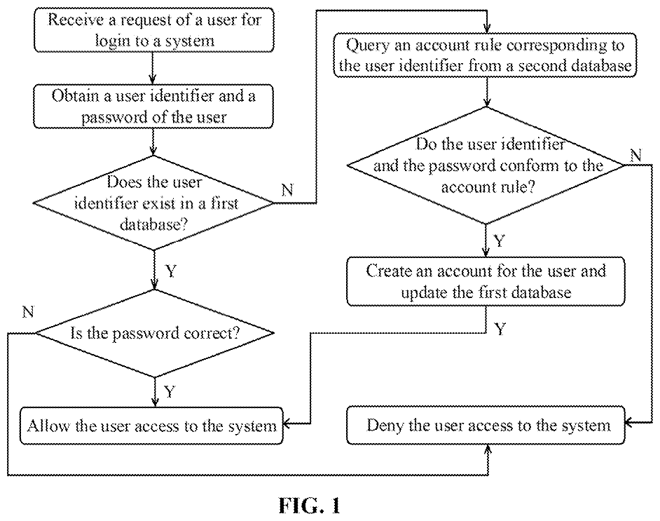

FIG. 1 shows a flow chart of one embodiment of a method of automatically creating accounts of the present disclosure. According to different requirements, the order of blocks is illustrative only and the order of the blocks can be changed. Additional blocks can be added or fewer blocks can be utilized without departing from this disclosure. The method can be applied to an electronic device.

The electronic device receives a request of a user for login to a system (i.e., login request). In response to the login request, the electronic device obtains a user identifier and a password entered by the user. The electronic device determines whether the user identifier exists in a first database. If the user identifier does not exist in the first database, the electronic device queries an account rule corresponding to the user identifier from a second database, and determines whether the user identifier and the password conform to the account rule. If the user identifier and the password conform to the account rule, the electronic device creates an account for the user, and stores the user identifier and the password into the first database (i.e., updates the first database). If the user identifier exists in the first database, the electronic device determines whether the password is correct. If the password is correct or after the account for the user is created, the electronic device allows the user access to the system. If the password is incorrect or the user identifier and the password do not conform to the account rule, the electronic device denies the user access to the system. If the password is incorrect or the user identifier and the password do not conform to the account rule, the electronic device may further issue an alert.

The first database stores accounts which are allowed access to the system. Each account in the first database includes a user identifier and a password. The second database stores account rules.

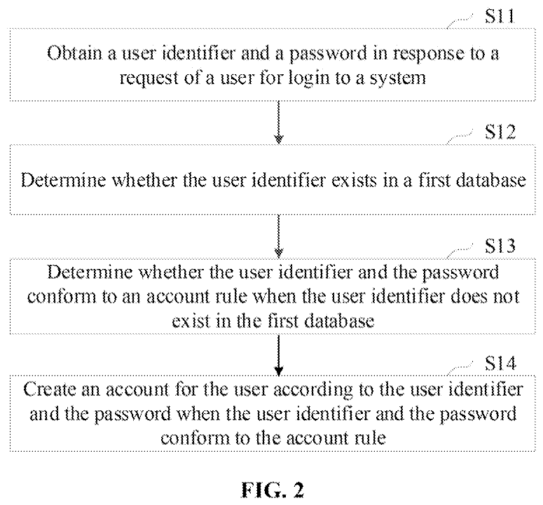

FIG. 2 shows a flow chart of another embodiment of the method of automatically creating accounts. According to different requirements, the order of blocks is illustrative only and the order of the blocks can be changed. Additional blocks can be added or fewer blocks can be utilized without departing from this disclosure.

At block S11, an electronic device obtains a user identifier and a password in response to a request of a user for login to a system (i.e., login request).

The user can send the login request through an application or an applet installed in a terminal. For example, the user send the login request by clicking a preset button on a user interface of the application. The electronic device can establish communication with multiple terminals, obtain a login request from each of the terminals; and create an account according to each login request. The terminals can install different applications that correspond to different systems.

In some embodiments, when receiving the login request of the user, the electronic device acquires a degree of urgency of the login request, adds the login request to a request queue according to the degree of urgency, and obtains the user identifier and the password according to the request queue.

The degree of urgency may be determined according to user information (such as an authority level) of the user. For example, an authority level of a user A is higher than that of a user B. A degree of urgency of the user A is therefore higher than that of the user B, and a login request of the user A is placed ahead of a login request of the user B in the request queue. Therefore, the electronic device obtains a user identifier and a password of the user A before obtaining a user identifier and a password of the user B.

At block S12, the electronic device determines whether the user identifier exists in a first database.

As mentioned above, the first database stores accounts allowed access to the system. Each account in the first database includes a user identifier and a password.

In some embodiments, the method may further include: when the user identifier exists in the first database, obtaining a first target password corresponding to the user identifier from the first database; determining whether the password matches the first target password; when the password matches the first target password, determining that the user has a login permission; and when the password does not match the first target password, determining that the user has not the login permission.

In one embodiment, when the password is identical to the first target password, it is determined that the password matches the first target password.

When determining that the user has a login permission, the electronic device allows the user access to the system.

In some embodiments, when determining that the user has not the login permission, the electronic device issues an alert.

The alert can be sent to a terminal of the user.

At block S13, the electronic device determines whether the user identifier and the password conform to an account rule when the user identifier does not exist in the first database.

There are different account rules applying to different user identifiers. For example, user identifiers starting with a number correspond to an account rule A1, and user identifiers starting, with a letter correspond to an account rule B1. For another example, user identifiers with 1 to 6 characters correspond to an account rule A2, and user identifiers with more than 6 characters correspond to an account rule B2.

The account rule may include a relationship between user identifiers and passwords. If the user identifier and the password are within the relationship, it is determined that the user identifier and the password conform to the account rule.

For example, the user identifier is X1, the password is Y1, and the relationship between user identifiers and passwords is Y=f1(X). If Y1=f1(X1), it is determined that the user identifier and the password conform to the account rule. If Y1≠f1(X1), it is determined that the user identifier and the password do not conform to the account rule.

Different account rules may apply to login requests for different systems. The electronic device can determine a system which corresponds to the login request, and obtain an account rule corresponding to the system. Account rules corresponding to different systems may be stored in a second database. After receiving the login request, the electronic device obtains the account rule corresponding to the system from the second database.

The account rules can be set according to requirements. For example, different account rules may be set according to security requirements of different accounts. If an account has high security requirements, a more complex account rule can be set.

The account rules can be modified according to requirements. Modified account rules take effect on accounts that are newly created.

In some embodiments, determining whether the user identifier and the password conform to an account rule includes: querying the account rule corresponding to the user identifier from a second database; and determining whether the user identifier and the password conform to the account rule.

After the account rule corresponding to the user identifier is obtained, whether the user identifier and the password conform to the account rule is determined.

In some embodiments, determining whether the user identifier and the password conform to the account rule includes: calculating a second target password according to the user identifier and the account rule; determining whether the password matches the second target password; and when the password matches the second target password, determining that the user identifier and the password conform to the account rule.

In one embodiment, when the password is identical to the second target password, it is determined that the user identifier and the password conform to the account rule.

For example, the user identifier is YH001. The password is 42dbffbc. The account rule corresponding to the user identifier specifies that a password is a combination of the 1st, 5th, 9th, 13th, 17th, 21st, 25th, and 29th bits of an encrypted value of a user identifier using Secure Hash Algorithm 1 (SHA-1). The electronic device performs SHA-1 encryption on the user identifier YH001 to obtain an actual encrypted value (such as 4a832831d9beb751fb5af5b6ba34c14ec241c9ab), and combines preset bits (such as the 1st, 5th, 9th, 13th, 17th, 21st, 25th, and 29th bits) of the actual encrypted value to obtain a second target password (such as 42dbffbc). If the password 42dbffbc is identical to the second target password, the electronic device determines that the user identifier and the password conform in to the account rule. If the password 42dbffbc is not identical to the second target password, the electronic device determines that the user identifier and the password do not conform to the account rule.

The second database may store different account rules that are used to create accounts with different permissions.

In some embodiments, determining whether the user identifier and the password conform to an account rule includes: determining a first format corresponding to the user identifier and a second format corresponding to the password; determining whether the first format and the second format exist in a second database; and determining that the user identifier and the password conform to the account rule when the first format and the second format exist in the second database.

Different user identifiers may correspond to different first formats, and different passwords may correspond to different second formats. For example, user identifiers starting with G correspond to a first format F1, and user identifiers starting with Y correspond to a first format F2. The second format includes a first combination of small letters and numbers, and a second combination of capital letters, small letters, and numbers, and so on.

Different first formats may correspond to different functions. For example, the first format F1 corresponds to functions of editing and viewing; the first format F2 corresponds to the function of viewing only.

The second database can store multiple first formats and multiple second formats. If the user identifier conforms to one of the multiple first formats, and the password conforms to one of the multiple second formats, it is determined that the user identifier and the password conform to the account rule.

In some embodiments, determining whether the first format and the second format exist in a second database includes: determining whether the first format exists in the second database; when the first format exists in the second database, obtaining a password format corresponding to the first format; determining whether the second format matches the password format; and when the second format matches the password format, determining that the second format exists in the second database.

The second database can store multiple first formats and a password format corresponding to each of the first formats. For example, the first format F1 corresponds to a password format P1. The password format P1 specifies performing SHA-1 encryption on the user identifier to obtain a first encrypted value, and determines a first password according to the 2nd, 6th, 10th, 14th, 18th, 22th, 26th, 30th bits of the first encrypted value. The first format F2 corresponds to a password format P2. The password format P2 specifies performing SHA-1 encryption on the user identifier to obtain the first encrypted value, and determining a second password according to the 3rd, 7th, 11th, 15th, 19th, 23rd, 27th, and 31st bits of the second encrypted value.

In some embodiments, determining whether the second format matches the password format includes: determining the second target password corresponding to the login request according to the password format; when the password is identical to the second target password, determining that the second format matches the password format.

The second target password corresponding to the login request can be determined according to the password format and the user identifier.

Setting a relationship between the first format and the password format improves the ease and accuracy of creating accounts and the security of the accounts.

In some embodiments, determining whether the user identifier and the password conform to the account rule includes: obtaining identity information of the user, and obtaining an account rule corresponding to the identity information in a second database; and determining whether the user identifier and the password conform to the account rule.

Different identity information may correspond to different account rules. For example, if the identity information shows that the user has a higher privilege, the account rule corresponding to the identity information is more complex; if the identity information shows that the user has a lower privilege, the account rule corresponding to the identity information is simpler.

Different account rules for different identity information improves the ease and accuracy of creating accounts and the security of the accounts.

At block S14, the electronic device creates an account for the user according to the user identifier and the password when the user identifier and the password conform to the account rule.

The account can be stored into the first database.

The method can automatically create accounts during the login process of users, which improves the efficiency of account creation. The method can create and unlimited number of accounts. By verifying whether the user identifier and the password conform to the account rules, the validity of the password is ensured, and the security of the account is improved.

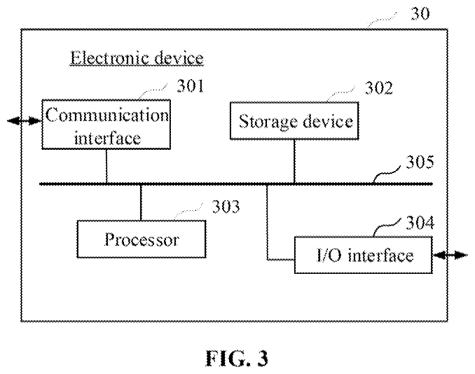

FIG. 3 illustrates an electronic device 30 for automatically creating accounts according to one embodiment of the present disclosure. The electronic device 30 can be a server or a terminal device.

The electronic device 30 can be included in a network. The network can include, but is not limited to, the Internet, a wide area network, a metropolitan area network, a local area network, a virtual private network (VPN), etc.

As shown in FIG. 3, the electronic device 30 includes a communication interface 301, a storage device 302, a processor 303, an input/output (I/O) interface 304, and a bus 305. The processor 303 is connected to the communication interface 301, the storage device 302, and the I/O interface 304 through the bus 305.

The communication interface 301 is used for communication. The communication interface 301 may be an existing interface of the electronic device 30 or a custom interface of the electronic device 30. The communication interface 301 may be a network interface, such as a wireless local area network (WLAN) interface, a cellular network communication interface, or a combination thereof.

The storage device 302 may be used to store program codes and various data of computer programs. For example, the storage device 302 may be used to store a automatically creating accounts system installed in the electronic device 30 and implement the running of stored programs or data during an operation of the electronic device 30. The storage device 302 may include a non-volatile storage medium and a volatile storage medium. The storage device 302 may include a hard disk, a memory, a plug-in hard disk, a smart memory card (SMC), a Secure Digital (SD) card, a flash card, at least one disk storage device, a flash memory device, or other storage medium.

The processor 303 provides computing and control capabilities of the electronic device 30. For example, the processor 303 executes a computer program stored in the storage device 302 to implement the blocks in the method of automatically creating accounts of FIG. 1 or FIG. 3.

The processor 303 may be a central processing unit (CPU) or other general-purpose processor, a digital signal processor (DSP), a disclosure specific integrated circuit (ASIC), a field-programmable gate array (FPGA) or other programmable logic device, a discrete gate, or a transistor logic device, or a discrete hardware component, etc. The processor 303 may be a microprocessor or any conventional processor.

The I/O interface 304 is used for input or output data. For example, the I/O interface 304 can be used to connect various input and output devices (mouse, keyboard, three-dimensional touch device, display screen, etc.) to input and output information.

The bus 305 is used to provide a communication channel among the communication interface 301, the storage device 302, the processor 303, and the I/O interface 304 in the electronic device 30.

Those skilled in the art can understand that the structure shown in FIG. 3 is only a representation of a structure related to the present disclosure, and does not constitute a limitation on the electronic device 30 to which the present disclosure is applied. Another example of the electronic device 30 may include more or fewer parts than shown in the figure, or combine some parts, or have a different arrangement of parts.

In one embodiment, the processor 303 executes computer-readable instructions stored in the storage device 302, to perform the operations: obtaining a user identifier and a password in response to a request of a user for login to a system; determining whether the user identifier exists in a first database; when the user identifier does not exist in the first database, determining whether the user identifier and the password conform to an account rule; and when the user identifier and the password conform to the account rule, creating an account for the user according to the user identifier and the password.

In some embodiments, the processor 303 executes the computer-readable instructions stored in the storage device 302, to further perform the operations: querying the account rule corresponding to the user identifier from a second database; and determining whether the user identifier and the password conform to the account rule.

In some embodiments, the processor 303 executes the computer-readable instructions stored in the storage device 302, to further perform the operations: determining a first format corresponding to the user identifier and a second format corresponding to the password; determining whether the first format and the second format exist in a second database; and determining that the user identifier and the password conform to the account rule when the first format and the second format exist in the second database.

In some embodiments, the processor 303 executes the computer-readable instructions stored in the storage device 302; to further perform the operations: determining whether the first format exists in the second database; when the first format exists in the second database; obtaining a password format corresponding to the first format; determining whether the second format matches the password format; and when the second format matches the password format, determining that the second format exists in the second database.

In some embodiments, the processor 303 executes the computer-readable instructions stored in the storage device 302, to further perform the operations: obtaining identity information of the user, and obtaining an account rule corresponding to the identity information in a second database; and determining whether the user identifier and the password conform to the account rule.

In some embodiments, the processor 303 executes the computer-readable instructions stored in the storage device 302, to further perform the operations: when the user identifier exists in the first database; obtaining a second target password corresponding to the user identifier from the first database; determining whether the password matches the second target password; when the password matches the second target password, determining that the user has a login permission; and when the password does not match the second target password, determining that the user has not the login permission.

In some embodiments, the processor 303 executes the computer-readable instructions stored in the storage device 302, to further perform the operations: issuing an alert.

In some embodiment, the processor 303 executes computer-readable instructions stored in the storage device 302, to perform the operations: querying the account rule corresponding to the login request from the second database; calculating a second target password according to the user identifier and the account rule; determining whether the password matches the second target password; and when the password matches the second target password, determining that the user identifier and the password conform to the account rule.

Details of the processor 303 executing the computer-readable instructions stored in the storage device 302 to implement the automatic creation of accounts can refer to the description of the method of automatically creating accounts in FIG. 1 and FIG. 2, and is not repeated here.

The present disclosure also provides a computer-readable storage medium of a permanent nature. The computer-readable storage medium stores a computer program, the computer program includes instructions. The instructions are executed by a processor of an electronic device to implement the method of automatically creating accounts.

The computer-readable storage medium may be an internal storage device of the electronic device described above, such as a hard disk or a memory of the electronic device. The computer-readable storage medium may also be an external storage device of the electronic device, such as a plug-in hard disk, a smart memory card (SMC), a secure digital (SD), and a flash card in the electronic device.

The present disclosure is not limited to the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or one device through software or hardware. Words such as “first” and “second” indicate names, but not any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

We claim:

1. A method of automatically creating accounts, comprising:
obtaining a user identifier and a password in response to a request of a user for login to a system;
determining whether the user identifier exists in a first database;
when the user identifier does not exist in the first database, determining whether the user identifier and the password conform to an account rule; and
when the user identifier and the password conform to the account rule, creating an account for the user according to the user identifier and the password.

2. The method of automatically creating accounts according to claim 1, wherein determining whether the user identifier and the password conform to an account rule comprises:
querying the account rule corresponding to the user identifier from a second database; and
determining whether the user identifier and the password conform to the account rule.

3. The method for automatic account activation according to claim 1, wherein determining whether the user identifier and the password conform to an account rule comprises:
determining a first format corresponding to the user identifier and a second format corresponding to the password;
determining whether the first format and the second format exist in a second database; and
determining that the user identifier and the password conform to the account rule when the first format and the second format exist in the second database.

4. The method of automatically creating accounts according to claim 3, wherein determining whether the first format and the second format exist in a second database comprises:
determining whether the first format exists in the second database;
when the first format exists in the second database, obtaining a password format corresponding to the first format;
determining whether the second format matches the password format; and
when the second format matches the password format, determining that the second format exists in the second database.

5. The method of automatically creating accounts according to claim 1, wherein determining whether the user identifier and the password conform in to the account rule comprises:
obtaining identity information of the user, and obtaining an account rule corresponding to the identity information in a second database; and
determining whether the user identifier and the password conform to the account rule.

6. The method of automatically creating accounts according to claim 1, further comprising:
when the user identifier exists in the first database, obtaining a first target password corresponding to the user identifier from the first database;
determining whether the password matches the first target password;
when the password matches the first target password, determining that the user has a login permission; and
when the password does not match the first target password, determining that the user has not the login permission.

7. The method of automatically creating accounts according to claim 6, further comprising:
issuing an alert.

8. The method of automatically creating accounts according to claim 1, wherein determining whether the user identifier and the password conform to the account rule comprises:
querying the account rule corresponding to the request from the second database;
calculating a second target password according to the user identifier and the account rule;
determining whether the password matches the second target password; and
when the password matches the second target password, determining that the user identifier and the password conform to the account rule.

9. An electronic device comprising:
at least one processor; and
a storage device storing computer-readable instructions, which when executed by the at least one processor, cause the at least one processor to:
obtain a user identifier and a password in response to a request of a user for login to a system;
determine whether the user identifier exists in a first database;
when the user identifier does not exist in the first database, determine whether the user identifier and the password conform to an account rule; and
when the user identifier and the password conform to the account rule, create an account for the user according to the user identifier and the password.

10. The electronic device according to claim 9, wherein the at least one processor is further caused to:
query the account rule corresponding to the user identifier from a second database; and
determine whether the user identifier and the password conform to the account rule.

11. The electronic device according to claim 9, wherein the at least one processor is further caused to:
determine a first format corresponding to the user identifier and a second format corresponding to the password;
determine whether the first format and the second format exist in a second database; and
determine that the user identifier and the password conform to the account rule when the first format and the second format exist in the second database.

12. The electronic device according to claim 11, wherein the at least one processor is further caused to:
determine whether the first format exists in the second database;
when the first format exists in the second database, obtain a password format corresponding to the first format;
determine whether the second format matches the password format; and
when the second format matches the password format, determine that the second format exists in the second database.

13. The electronic device according to claim 9, wherein the at least one processor is further caused to:
obtain identity information of the user, and obtain an account rule corresponding to the identity information in a second database; and
determine whether the user identifier and the password conform to the account rule.

14. The electronic device according to claim 9, wherein the at least one processor is further caused to:
when the user identifier exists in the first database, obtain a first target password corresponding to the user identifier from the first database;
determine whether the password matches the first target password;
when the password matches the first target password, determine that the user has a login permission; and
when the password does not match the first target password, determine that the user has not the login permission.

15. A non-transitory storage medium having instructions stored thereon, when the instructions are executed by a processor of an electronic device, the processor is configured to perform a method of automatically creating accounts, the method comprising:
obtaining a user identifier and a password in response to a request of a user for login to a system;
determining whether the user identifier exists in a first database;
when the user identifier does not exist in the first database, determining whether the user identifier and the password conform to an account rule; and
when the user identifier and the password conform to the account rule, creating an account for the user according to the user identifier and the password.

16. The non-transitory storage medium according to claim 15, wherein determining whether the user identifier and the password conform to an account rule comprises:
querying the account rule corresponding to the user identifier from a second database; and
determining whether the user identifier and the password conform to the account rule.

17. The non-transitory storage medium according to claim 15, wherein determining whether the user identifier and the password conform to an account rule comprises:
determining a first format corresponding to the user identifier and a second format corresponding to the password;
determining whether the first format and the second format exist in a second database; and
determining that the user identifier and the password conform to the account rule when the first format and the second format exist in the second database.

18. The non-transitory storage medium according to claim 17, wherein determining whether the first format and the second format exist in a second database comprises:
determining whether the first format exists in the second database;
when the first format exists in the second database, obtaining a password format corresponding to the first format;
determining whether the second format matches the password format; and
when the second format matches the password format, determining that the second format exists in the second database.

19. The non-transitory storage medium according to claim 15, wherein determining whether the user identifier and the password conform to the account rule comprises:
obtaining identity information of the user, and obtaining an account rule corresponding to the identity information in a second database; and
determining whether the user identifier and the password conform to the account rule.

20. The non-transitory storage medium according to claim 5, the method further comprising:
when the user identifier exists in the first database, obtaining a first target password corresponding to the user identifier from the first database;
determining whether the password matches the first target password;
when the password matches the first target password, determining that the user has a login permission; and
when the password does not match the first target password, determining that the user has not the login permission.
